(19) United States
(12) Patent Application Publication
(10) Pub. No.: US 2015/0245559 A1
(43) Pub. Date: Sep. 3, 2015

(54) LAWN MOWER WITH AN AUTOMATIC CLUTCH

(71) Applicants: Jian Yang, Shanghai (CN); Xiaofei Li, Shanghai (CN)

(72) Inventors: Jian Yang, Shanghai (CN); Xiaofei Li, Shanghai (CN)

(21) Appl. No.: 14/371,505

(22) PCT Filed: Sep. 3, 2012
(86) PCT No.: PCT/CN2012/080930

§ 371 Date: Jul. 10, 2014

(30) Foreign Application Priority Data
Jan. 11, 2012 (CN) 201220011350.4

(51) Int. Cl. A01D 34/68; A01D 34/64; A01D 34/69; A01D 34/00

(52) U.S. Cl. CPC A01D 34/6812; A01D 34/006; A01D 34/64; A01D 34/69; A01D 2034/6843

(57) ABSTRACT

A lawn mower with an automatic clutch has a shell, one or more blades pivotally installed in the shell, an engine in the shell for driving the blades to cut grass, a self-propelled motor in the shell, a retarding mechanism fixed with respect to the self-propelled motor, a self-propelled shaft driven by the retarding mechanism, a pair of rear wheels driven by the self-propelled shaft, a pair of front wheels on a front portion of the shell, a handle on a rear portion of the shell, a power, a control mechanism on the handle, and an automatic clutch provided between the self-propelled motor and the retarding mechanism. The automatic clutch has a tubular shell, an output shaft, a pair of symmetric block, a pair of elastic elements, an input shaft, and a crow block.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to an electric lawn mower, and more particularly, to a lawn mower having an automatic clutch which is able to disengage when a self-propelled motor thereof stops. The clutch makes the lawn mower easy to be pulled or pushed after the self-propelled motor stops.

2. Description of Related Art

Self-propelled lawn mower is a common tool. An earlier conventional lawn mower usually has a shell, one or more blades pivotally installed in the shell, an engine in the shell for driving the blades to cut grass, a self-propelled motor in the shell, a self-propelled shaft pivotally installed in a rear portion of the shell, a pair of rear wheels on the self-propelled shaft, a retarding mechanism between the self-propelled motor and the self-propelled shaft, a pair of front wheels on a front portion of the shell, a handle on the rear portion of the shell, a power, and a control mechanism on the handle.

One drawback of this lawn mower is that the pair of rear wheels stops with respect to the self-propelled motor when self-propelled motor stops. The lawn mower becomes hard to push or pull when the self-propelled motor stops. In order to resolve this problem, an improved lawn mower having a clutch has been disclosed. A clutch is provided between the self-propelled motor and the retarding mechanism. A user is able to disengage the clutch by operating a control near the handle after the self-propelled motor stops. Then the pair of rear wheels will be disengaged with the self-propelled motor, and the user will be able to push or pull the lawn mower after the self-propelled motor stops.

However all the self-propelled motors with clutch are manual operation, which means the user needs to manually operate to disengage the clutch after the self-propelled motor stops. This brings much inconvenience to the user.

### BRIEF SUMMARY OF THE INVENTION

The main object of the invention is to provide a lawn mower with an automatic clutch which is able to automatically disengage after the self-propelled motor stops to work.

In order to achieve above object, the invention provides a lawn mower with an automatic clutch. The lawn mower has a shell, one or more blades pivotally installed in the shell, an engine in the shell for driving the blades to cut grass, a self-propelled motor in the shell, a retarding mechanism fixed with respect to the self-propelled motor, a self-propelled shaft driven by the retarding mechanism, a pair of rear wheels driven by the self-propelled shaft, a pair of front wheels on a front portion of the shell, a handle on a rear portion of the shell, a power, a control mechanism on the handle, and an automatic clutch provided between the self-propelled motor and the retarding mechanism. The automatic clutch has a tubular shell, an output shaft fixed to one side of the tubular shell, a pair of symmetric block received in the tubular shell, a pair of elastic elements urging the pair of symmetric block towards each other, an input shaft passing through the pair of symmetric block and being fixed to the other side of the tubular shell opposite to the output shaft with a bearing, and a crow block fixed to the input shaft. Each symmetric block has an arc periphery and a central cross groove. Both arc periphery and a tubular inner wall of the tubular shell have friction therebetween. The crow block is slidably received in the central cross grooves of the symmetric blocks. The self-propelled motor drives the input shaft via a power transmission element.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a schematic exploded perspective view of the preferred embodiment of a lawn mower with an automatic clutch of the invention.

FIG. 2 is a partially enlarged perspective schematic view of the lawn mower shown in FIG. 1.

FIG. 3 is an enlarged plane view showing the portion shown in FIG. 2 with a retarding mechanism shell being removed.

FIG. 4 is another partial enlarged perspective view of the lawn mower shown in FIG. 1.

FIG. 5 is another partially enlarged perspective exploded view of the lawn mower shown in FIG. 1. And,

FIG. 6 is yet another partially enlarged perspective exploded view of the lawn mower shown in FIG. 1.

### DETAILED DESCRIPTION OF THE INVENTION

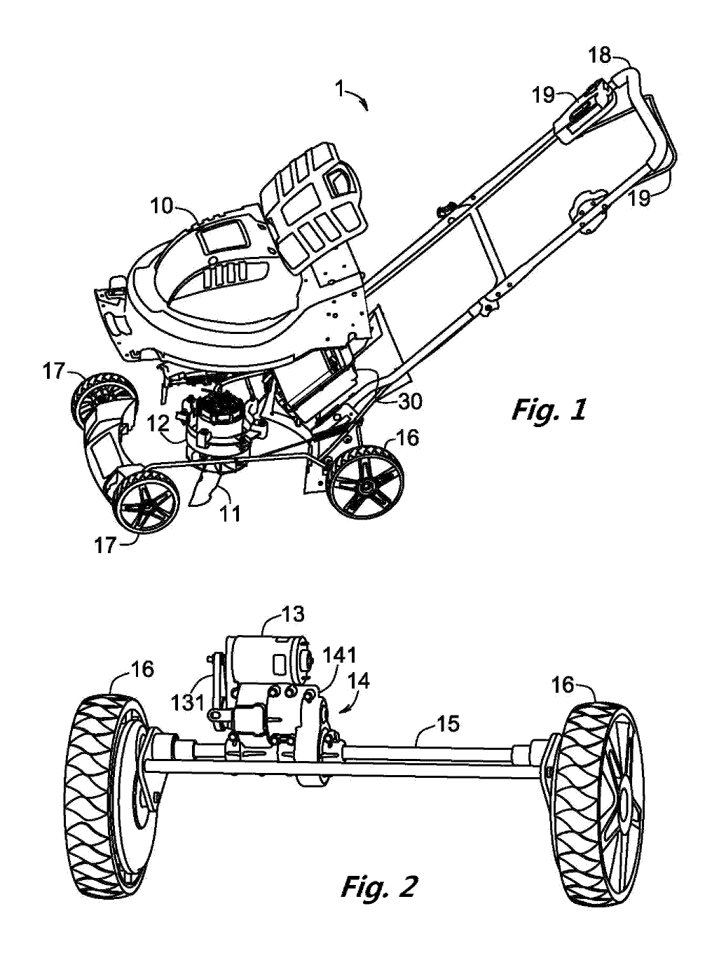

With reference to FIGS. 1 and 2, the preferred embodiment of a lawn mower with an automatic clutch of the invention is shown. The lawn mower 1 has a shell 10, one or more blades 11 pivotally installed in the shell 10, an engine 12 in the shell 10 for driving the blades 11 to cut grass, a self-propelled motor 13 in the shell 10, a retarding mechanism 14 fixed with respect to the self-propelled motor 13, a self-propelled shaft 15 driven by the retarding mechanism 14, a pair of rear wheels 16 driven by the self-propelled shaft 15, a pair of front wheels 17 on a front portion of the shell 10, a handle 18 on a rear portion of the shell 10, a power 30 and a control mechanism 19 on the handle 18. In this embodiment, the retarding mechanism 14 is fixed with respect to the self-propelled motor 13 with a retarding mechanism shell 141, and the self-propelled shaft 15 passes the retarding mechanism 141 through bearings 151.

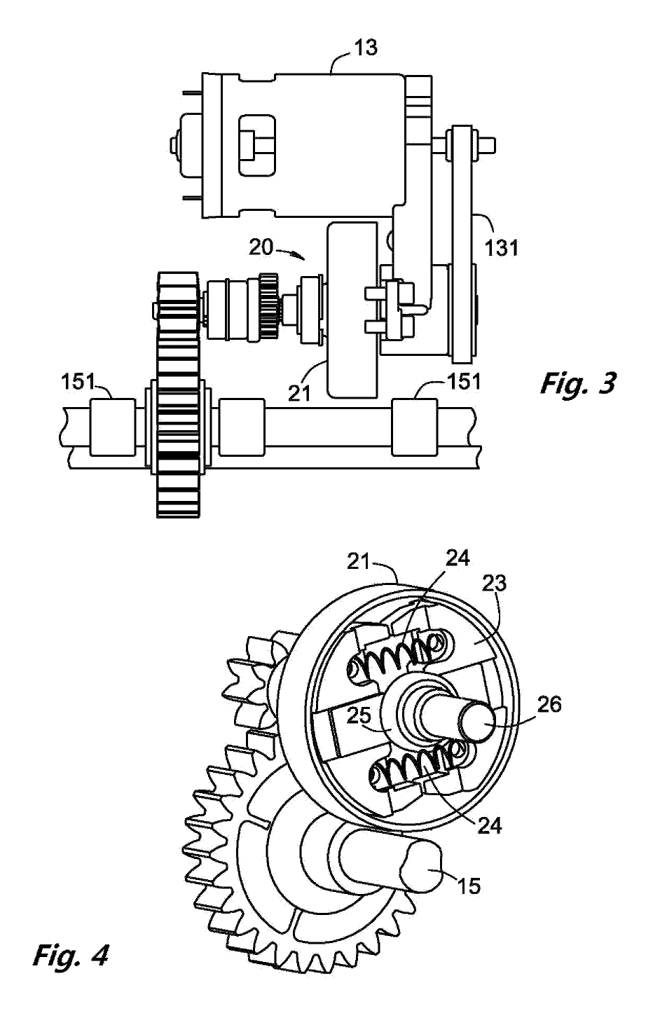

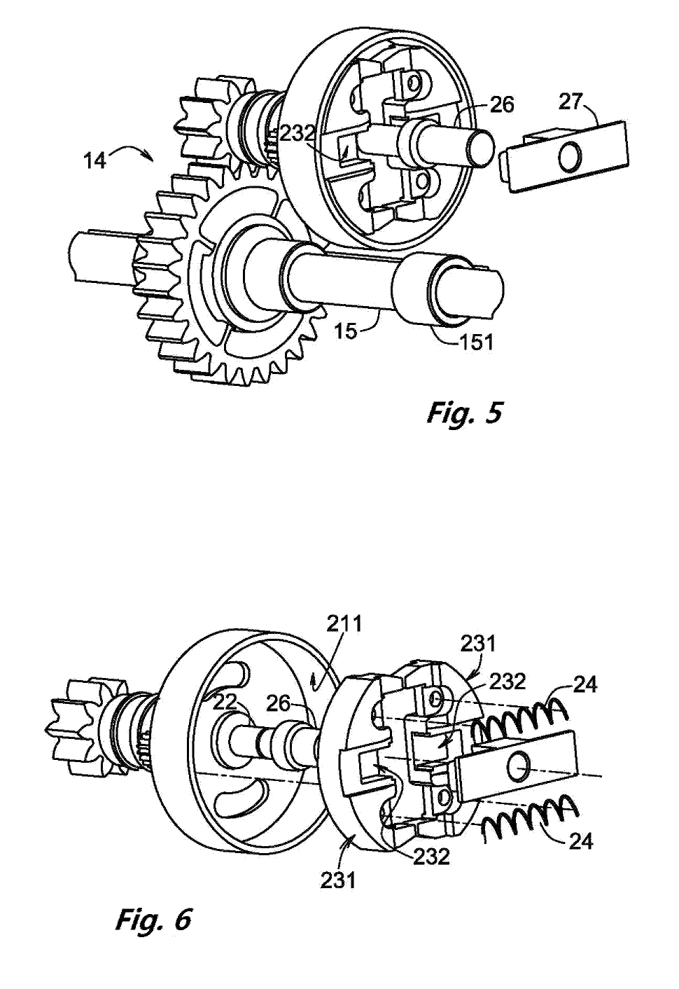

As shown in FIG. 3, an improvement of the invention is an automatic clutch 20 provided between the self-propelled motor 13 and the retarding mechanism 14. With reference to FIGS. 4, 5, and 6, the automatic clutch 20 has a tubular shell 21, an output shaft 22 fixed to one side of the tubular shell 21, a pair of symmetric block 23 received in the tubular shell 21, a pair of elastic elements 24 urging the pair of symmetric block 23 towards each other, an input shaft 26 passing through the pair of symmetric block 23 and being fixed to the other side of the tubular shell 21 opposite to the output shaft 22 with a bearing 25, and a crow block 27 fixed to the input shaft 26. Each symmetric block 23 has an arc periphery 231 and a central cross groove 232. There is a certain friction between both arc periphery 231 and a tubular inner wall 211 of the tubular shell 21. The crow block 27 is slidably received in the central cross grooves 232 of the symmetric blocks 23, making the pair of symmetric blocks 23 reciprocally slidable along the crow block 27. A driving power from the self-propelled motor 13 is able to drive the input shaft 26 via a power transmission element 131. In this embodiment, the pair of elastic elements 24 are two identical springs.

In use, a user is able to turn on the engine 12 and the self-propelled motor 13 by operating of control mechanism 19 on the handle 18. Power is transmitted from the self-propelled motor 13 to the input shaft 26 of the automatic clutch 20 by the triangle belt 131. The input shaft 26 drives the crow block 27 to rotate, and the crow block 27, received in the central cross grooves 232, then drives the symmetric blocks 23 to rotate. When the symmetric blocks 23 rotate, an inertia force thereof will pull the symmetric blocks 23 against the pair of elastic elements 24 to move centrifugally until the arc peripheries 231 thereof meet and press on the tubular inner wall 211 of the tubular shell 21. A friction force between the arc peripheries 231 and the tubular inner wall 211 increases as a rotate speed of the self-propelled motor 13 increases. After the friction force becomes great enough, the tubular shell 21 will be driven to rotate by the friction force. The output shaft 22 fixed to the other side of the tubular shell 21 rotates accordingly, driving the retarding mechanism 14. The self-propelled shaft 15, and thus the rear wheels 16, are driven to rotate. At this time, the automatic clutch 20 is in a status of being engaged.

If the user turns off the engine 12 and the self-propelled motor 13 by the control mechanism 19, the crow block 27 will gradually stop to rotate and the centrifugal force on the symmetric blocks 23 disappears little by little. The symmetric blocks 23 will be pulled towards each other under a pulling force from the elastic elements 24 along the crow block 27. The arc peripheries 231 leave the tubular inner wall 211. At this time, the automatic clutch 20 is in a status of being disengaged. The rear wheels 16, the self-propelled shaft 15 and the retarding mechanism 14 departure from the self-propelled motor 13 and the user is able to pull or push the lawn mower 1 easily.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. A lawn mower with an automatic clutch comprising:
a shell, one or more blades pivotally installed in the shell, an engine in the shell for driving the blades to cut grass, a self-propelled motor in the shell, a retarding mechanism fixed with respect to the self-propelled motor, a self-propelled shaft driven by the retarding mechanism, a pair of rear wheels driven by the self-propelled shall, a pair of front wheels on a front portion of the shell, a handle on a rear portion of the shell, a power, a control mechanism on the handle and an automatic clutch provided between the self-propelled motor and the retarding mechanism, the automatic clutch having a tubular shell, an output shaft fixed to one side of the tubular shell, a pair of symmetric block received in the tubular shell, a pair of elastic elements urging the pair of symmetric block towards each other, an input shaft passing through the pair of symmetric block and being fixed to the other side of the tubular shell opposite to the output shaft with a bearing, and a crow block fixed to the input shaft, each symmetric block having an arc periphery and a central cross groove, both arc periphery and a tubular inner wall of the tubular shell having friction therebetween, the crow block being slidably received in the central cross grooves of the symmetric blocks, the self-propelled motor driving the input shaft via a power transmission element.

2. The lawn mower with an automatic clutch as claimed in claim 1, wherein the retarding mechanism is fixed with respect to the self-propelled motor with a retarding mechanism shell.

3. The lawn mower with an automatic clutch as claimed in claim 1, wherein the self-propelled shaft passes the retarding mechanism through bearings.
